(19) United States
(12) Patent Application Publication
(10) Pub. No.: US 2016/0341832 A1
(43) Pub. Date: Nov. 24, 2016

(54) Microchip Composite Structure of Ce:Yag and Production Method

(71) Applicant: DM Lighting Technologies Inc., Montclair, CA (US)

(72) Inventors: Dun-Hua Cao, Kunshan Suzhou (CN); Yong-Jun Dong, Kunshan Suzhou (CN); Yue-Shan Liang, Kunshan Suzhou (CN)

(21) Appl. No.: 14/719,288

(22) Filed: May 21, 2015

(51) Int. Cl. G01T 1/202

(52) U.S. Cl. CPC G01T 1/2023

(57) ABSTRACT

The present invention relates to a Ce:YAG wafer-based composite structure comprising a Ce:YAG wafer and a red light emitting layer fixed on the Ce:YAG wafer. The present invention also relates to a method for the preparation of the Ce:YAG wafer-based composite structure. The optical composite structure realizes a wide waveband luminescence from green light to red light, and can be widely used in the fields of detection equipment and illumination devices.

### TECHNICAL FIELD OF THE INVENTION

The present invention belongs to optical field, and in particular, relates to a Ce:YAG wafer-based composite structure and method for the preparation thereof.

### TECHNICAL BACKGROUND

Cerium ion doped yttrium aluminum garnet (Ce:Y₃Al₅O₁₂ or Ce:YAG) is a novel inorganic scintillation crystal developed in 1980's. Ce:YAG has broad application prospects in the fields, such as high energy physics, nuclear physics, nuclear medical imaging, industrial in-line detection and lighting fields due to its excellent properties, such as high light output and low decay time constant and the like. In addition to high light output (20,000 Ph/MeV) and fast time decay (88 ns/300 ns), Ce:YAG scintillation crystal also shows good properties in: well distinguishing ε ray and α particle by light pulses; emitting 550 nm fluoresces which can be effectively coupled with silicon photodiode; capable of being excited by blue light having a wavelength ranged from 435 nm to 470 nm and combined with the same to form a white light; having excellent physical-chemical properties of a YAG substrate; among others. Furthermore, Ce:YAG crystal can be grown to a large size, cut with simple process, and processed into wafers of various shapes, and thus can be widely used.

Although Ce:YAG wafer shows the above excellent properties, the wavelength thereof is relatively localized with a main emission peak at 525 nm˜550 nm and a peak width of 65 nm˜75 nm. As a result, the efficacy of Ce:YAG wafer in some applications where long wavelength detection or lighting are needed is reduced.

### SUMMARY

The technical problem to be solved by the present invention is to overcome the drawbacks in the prior art by adding a red light emitting layer on the surface of the Ce:YAG wafer to form an optical composite structure having a wide band luminescence from green light to red light.

The present invention provides a Ce:YAG wafer-based composite structure comprising: a Ce:YAG wafer; and, a red light emitting layer fixed on said Ce:YAG wafer.

Preferably, the main emission peak of said red light emitting layer is at 580 nm˜660 nm.

Preferably, the red light emitting layer is a red light emitting film doped with red fluorescent powder.

Preferably, the red light emitting layer may also be a transparent colloid layer doped with red fluorescent powder.

Preferably, the red light emitting layer is a crystalline, a ceramic or a glass doped with red light luminescence center.

To solve the above problem, the present invention further provides a method for the preparation of a Ce:YAG wafer-based composite structure comprising the steps of:

(1) producing a Ce:YAG wafer by Czochralski process, temperature gradient process or Kyropoulos process;

(2) grinding and polishing the Ce:YAG wafer produced in step (1) to obtain a fluorescent wafer having desired size; and

(3) adding a red light emitting layer on the fluorescent wafer obtained in step (2).

Preferably, the red light emitting layer added in step (3) is a red light emitting film deposited by physical or chemical vapor deposition.

Preferably, the red light emitting layer added in step (3) is a transparent colloid layer doped with red fluorescent powder.

Preferably, the red light emitting layer added in step (3) is a crystalline, a ceramic or a glass doped with red light luminescence center of rare earth or transition metal and fixed on the fluorescent wafer.

The Ce:YAG wafer of the present invention has an emitting wavelength of 520 nm˜600 nm, and a main peak at 525 nm˜550 nm; and, in the red light emitting layer, fluorescent powder having an emitting wavelength of 580 nm˜660 nm is selected or red light emitting ions are directly doped in the matrix. The two wavebands combine to form a wide emission peak and thus realizing a wide waveband luminescence from green light to red light. The red fluorescent powders selected are mainly Eu element luminescent powders having a luminescence decay time of the order of microsecond.

As compared to the structures in the prior art, the composite structure based on the Ce:YAG wafer produced by the method of the present invention shows the following beneficial effects:

1) low cost, diverse processing methods, simple process; and

2) high light yield, excellent time characteristics, wide emission spectrum, and good color rendering effect.

### BRIEF DESCRIPTION OF THE DRAWINGS

FIG. 1 is a schematic diagram showing the structure prepared in the examples of the present invention.

FIG. 2 is a luminescence spectrum of the composite structure deposited with Eu:Y₂O₃ film prepared in Example 1.

FIG. 3 is a luminescence spectrum of the composite structure of Example 2, which was prepared by depositing a film of red fluorescent powder via gelatinization.

FIG. 4 is a luminescence spectrum of the composite structure of Example 3, in which a Eu:YAG wafer was affixed with silica gel.

FIG. 5 is a luminescence spectrum of the composite structure of Example 5.

FIG. 6 is a luminescence spectrum of the composite structure of Example 6.

In the figures, “1” represents Ce:YAG fluorescent wafer; and “2” represents red light emission layer.

### DETAILED DESCRIPTION OF THE EMBODIMENTS

The present invention will be further illustrated by embodiments referencing the accompanying drawings.

FIG. 1 is a schematic diagram showing the Ce:YAG wafer-based composite structure prepared in the examples of the present invention, wherein the composite structure comprises a Ce:YAG wafer 1 and a red light emitting layer 2 fixed on said Ce:YAG wafer 1.

### EXAMPLE 1

Sputter deposition of an Eu:Y₂O₃ film:

Eu:Y₂O₃ powder having an Eu ion molar concentration of 0.2% was provided and pressed into a target block. Then, the Eu:Y₂O₃ target was fixed to the cathode of a sputtering coater. A Ce:YAG wafer (the molar concentration of Ce ion in the wafer was 0.3%) was prepared by Czochralski process, grinded and polished into desired size. The Ce:YAG wafer was rinsed and fixed to an anode arranged opposite to the surface of the target. The system was evacuated to a high vacuum degree (10⁻³ Pa) and then charged with Ar (5 Pa). The coating was started by applying voltage between the cathode and the anode. At the end of coating, the system was evacuated, charged with Ar and cooled. A Ce:YAG wafer-based luminescent composite structure deposited with Eu:Y₂O₃ red light emitting film was finally obtained.

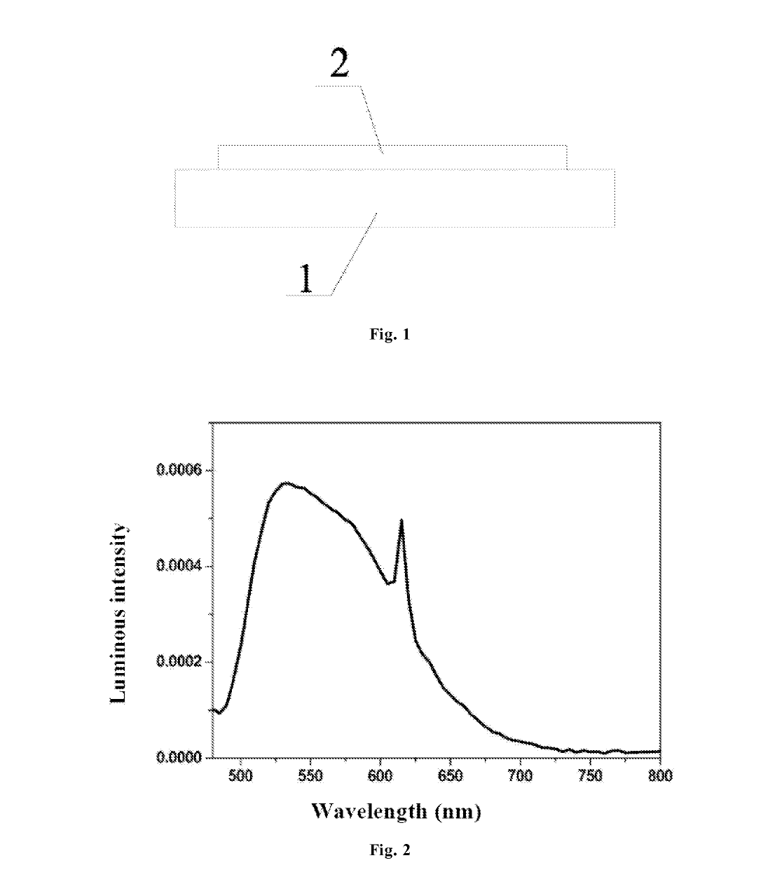

FIG. 2 is a luminescence spectrum of the composite structure deposited with Eu:Y₂O₃ film prepared in Example 1. The figure shows that: the composite structure deposited with Eu:Y₂O₃ film has a wide emitting spectrum at 500 nm˜700 nm, and thus achieving a wide waveband luminescence from green light to red light.

### EXAMPLE 2

Deposition of a red fluorescent powder film via gelatinization: 0.05 wt % of red fluorescent powder was added to silica gel. After thoroughly mixing, the resultant mixture was applied by spray coating to evenly cover the surface of a Ce:YAG wafer prepared by temperature gradient technique (the molar concentration of Ce ion in the wafer was 0.3%). The coated wafer was baked at 120° C. for 3 hours. A Ce:YAG wafer-based composite structure deposited with red fluorescent powder film was obtained after the solidification of the gel.

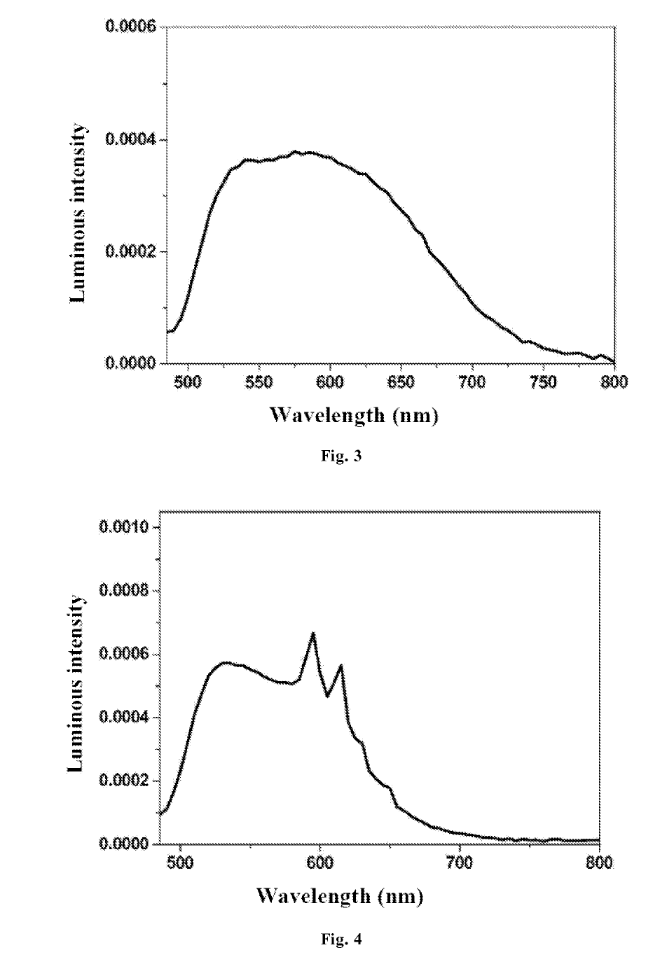

FIG. 3 is a luminescence spectrum of the composite structure prepared by depositing red fluorescent powder via gelatinization in Example 2. The figure shows that: the composite structure deposited with red fluorescent powder film by gelatinization has a wide emitting spectrum at 500 nm˜750 nm, and thus achieving a wide waveband luminescence from green light to red light.

### EXAMPLE 3

In this example, a Eu:YAG wafer prepared by Kyropoulos technique (the molar concentration of Eu ion in the Eu:YAG wafer was 0.2%) was affixed to a Ce:YAG wafer prepared by temperature gradient technique (the molar concentration of Ce ion in the Ce:YAG wafer was 0.5%) with silica gel. The surfaces of the Ce:YAG wafer and the Eu:YAG wafer were polished to obtain good fineness and flatness. The surface of the Ce:YAG wafer was coated with silica gel, and then the Eu:YAG wafer was laminated on the silica gel coating. The structure was baked at 100° C. for 3 hours followed by slowly cooling to room temperature. A luminescent composite structure comprising Ce:YAG wafer and Eu:YAG wafer was thus obtained.

FIG. 4 is a luminescence spectrum of the composite structure prepared by affixing Eu:YAG wafer with silica gel in Example 3. The figure shows that: the composite structure prepared by affixing Eu:YAG wafer with silica gel has a wide emitting spectrum at 500 nm˜700 nm, and thus achieving a wide waveband luminescence from green light to red light.

### EXAMPLE 4

In this example, a Eu:YAG wafer prepared by Kyropoulos technique (the molar concentration of Eu ion in the Eu:YAG wafer was 0.2%) was affixed to a Ce:YAG wafer prepared by temperature gradient technique (the molar concentration of Ce ion in the Ce:YAG wafer was 0.5%) by way of thermal bonding. The surfaces of the Ce:YAG wafer and the Eu:YAG wafer were polished to obtain good fineness and flatness. Two polished surfaces of the two wafers were affixed at room temperature to form hydrogen bond linkages via the molecular membranes adsorbed on the surfaces so as to complete the gloss lamination at room temperature. The bonded wafers were placed into a thermo-compressor, heated to 1200° C. and kept at the temperature for 4 hours. The linked Ce:YAG wafer and Eu:YAG wafer structure was obtained after being slowly cooled to room temperature.

### EXAMPLE 5

A certain amount of red fluorescent powder was weighted and added into low melting point glass powder and evenly mixed to form a mixture comprising 0.045 wt % of red fluorescent powder based on the total weight. The glass powder was applied on a Ce:YAG wafer prepared by temperature gradient technique (the molar concentration of Ce ion in the wafer was 0.5%). The wafer covered by glass powder was placed into a sealed high temperature furnace which was charged with N₂ as protection gas and set to one atmosphere. The furnace was heated to 400° C. at a rate of 200° C./hour and kept constant at that temperature for 20 minutes during which the glass powder completely melted and closely adhered to the wafer, and then the furnace was cooled to room temperature at a rate of 400° C./hour. A luminescent composite structure comprising Ce:YAG wafer and red light glass layer was thus obtained.

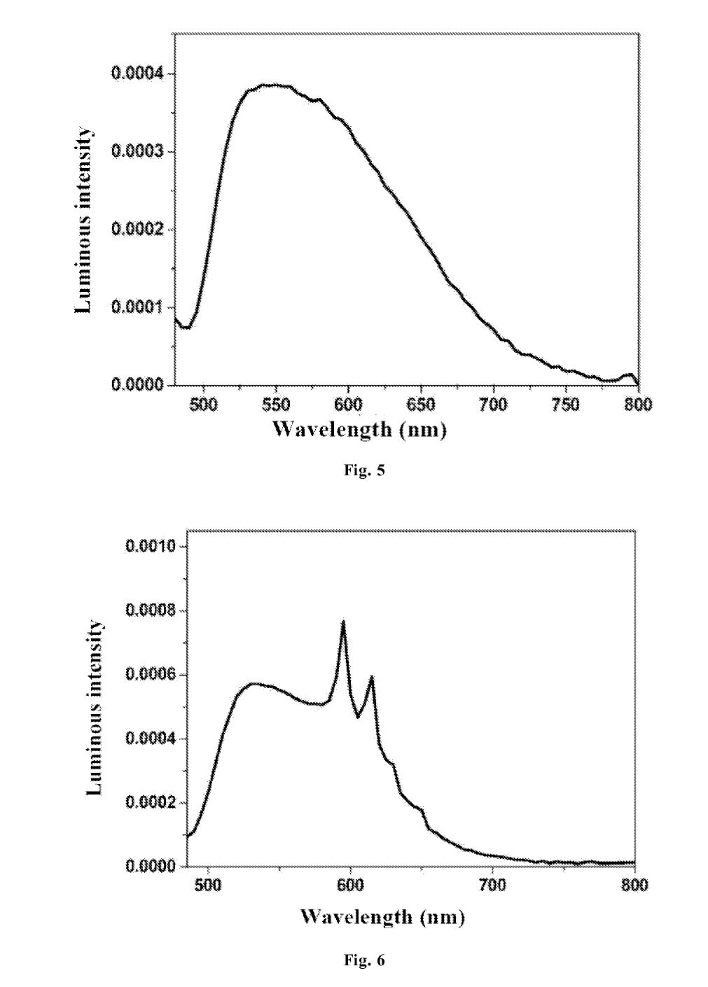

FIG. 5 is a luminescence spectrum of the composite structure of Example 5. The figure shows that: the composite structure has a wide emitting spectrum at 500 nm˜725 nm, and thus achieving a wide waveband luminescence from green light to red light.

### EXAMPLE 6

In this example, an Eu:YAG transparent ceramic sheet (commercially available; the molar concentration of Eu ion in the sheet was 0.3%) was affixed to a Ce:YAG wafer prepared by temperature gradient technique (the molar concentration of Ce ion in the wafer was 0.5%) with silica gel. The surfaces of the Ce:YAG wafer and the Eu:YAG transparent ceramic sheet were polished to obtain good fineness and flatness. The surface of the Ce:YAG wafer was coated with silica gel, and then the Eu:YAG transparent ceramic sheet was laminated on the silica gel coating. The laminate was baked at 100° C. for 3 hours, followed by slowly cooling to room temperature. A luminescent composite structure comprising Ce:YAG wafer and Eu:YAG transparent ceramic sheet was thus obtained.

FIG. 6 is a luminescence spectrum of the composite structure of Example 6. The figure shows that: the composite structure has a wide emitting spectrum at 500 nm˜700 nm, and thus achieving a wide waveband luminescence from green light to red light.

The purpose, technical solutions and beneficial effects of the present invention are described with reference to the above particular examples. Nevertheless, it will be understood that the above examples are not provided to limit the present invention. The invention is intended to cover various modifications and equivalent arrangements included within the spirit and scope of the claims.

1. A Ce:YAG wafer-based composite structure, wherein said composite structure comprises:
a Ce:YAG wafer; and
a red light emitting layer fixed on said Ce:YAG wafer.

2. The Ce:YAG wafer-based composite structure according to claim 1, wherein the main emission peak of said red light emitting layer is at 580 nm˜660 nm.

3. The Ce:YAG wafer-based composite structure according to claim 2, wherein said red light emitting layer is a deposited film capable of emitting red light.

4. The Ce:YAG wafer-based composite structure according to claim 2, wherein said red light emitting layer is a transparent colloid layer doped with red fluorescent powder.

5. The Ce:YAG wafer-based composite structure according to claim 2, wherein said red light emitting layer is a crystalline, a ceramic or a glass doped with red light luminescence center.

6. A method for the preparation of a Ce:YAG wafer-based composite structure, comprising:
(1) producing a Ce:YAG wafer by Czochralski process, temperature gradient process or Kyropoulos process;
(2) grinding and polishing the Ce:YAG wafer produced in step (1) to obtain a fluorescent wafer having desired size; and
(3) adding a red light emitting layer on the fluorescent wafer obtained in step (2).

7. The method for the preparation of a Ce:YAG wafer-based composite structure according to claim 6, wherein the red light emitting layer added in step (3) is a red light emitting film deposited by physical or chemical vapor deposition.

8. The method for the preparation of a Ce:YAG wafer-based composite structure according to claim 6, wherein the red light emitting layer added in step (3) is a transparent colloid layer doped with red fluorescent powder.

9. The method for the preparation of a Ce:YAG wafer-based composite structure according to claim 6, wherein the red light emitting layer added in step (3) is a crystalline, a ceramic or a glass doped with red light luminescence center of rare earth or transition metal and fixed on the fluorescent wafer.
